(19) United States
(12) Patent Application Publication
(10) Pub. No.: US 2012/0104948 A1
(43) Pub. Date: May 3, 2012

(54) COMPACT FLUORESCENT LAMP WITH IMPROVED PERFORMANCE AND SIZE

(76) Inventors: Istvan Wursching, Budapest (HU); Jozsef Fulop, Budapest (HU); Ferenc Papp, Budapest (HU); Laszlo Bankuti, Budapest (HU)

(21) Appl. No.: 12/915,131

(22) Filed: Oct. 29, 2010

(51) Int. Cl. H01J 7/44; H01J 9/24

(52) U.S. Cl. 315/56; 445/26

(57) ABSTRACT

A compact fluorescent lamp includes a discharge tube forming a continuous arc path with electrodes disposed at each end of the path. The lamp includes a fill gas disposed within the discharge tube. The lamp further includes a ballast circuit for controlling current in the discharge tube and operatively connected to the electrodes. The discharge tube is spirally wound around the longitudinal axis of the lamp to form a partially closed cavity and in a preferred arrangement the ballast is positioned within cavity formed by the spirally wound discharge tube. A gap between adjacent turns of the spirally wound discharge tube is less than about 0.5 mm, and preferably about 0.0009 mm.

### BACKGROUND OF THE DISCLOSURE

The present disclosure relates to a low pressure mercury vapor discharge lamp and, more specifically, to a compact fluorescent lamp that can replace incandescent lamps of general purpose. The compact fluorescent lamp finds particular application in a wide field of industry and home applications, although it will be appreciated that selected aspects may find application in related environments encountering the same issues with regard to increased lamp efficacy in similar or decreased lamp size.

The majority of known and commercially available low-pressure fluorescent discharge lamps are compact fluorescent lamps. These lamps are intended to replace incandescent lamps used in a wide field of industry and home applications. Main advantages of these lamps are low-power consumption and a long life. Disadvantages of compact fluorescent lamps, however, are their relatively high cost and longer length dimension. Many configurations have been proposed to solve the length issue.

A current configuration for increasing lamp efficacy for compact fluorescent lamps includes increasing arc length and arc voltage which in turn uses lower arc current resulting in higher lumen output based on the same power consumption. However, this is generally achieved by increasing the maximum overall length (MOL) of the lamp.

Another configuration uses a smaller sized electronic ballast and thereby reduces the maximum overall length (MOL) but this lamp configuration increases costs. Further, a reduced electronic ballast dimension generally has a higher component temperature. The increase in electronic ballast temperature generally reduces system reliability.

Still another consideration for manufacturing a reliable, longer life compact fluorescent lamp system is to use high quality electronic parts. However, this prepared solution results in higher costs.

Even in light of recent advances, the industry continues to lack a similar or even smaller compact fluorescent lamp that is cost-effective, easily manufactured and able to achieve an increased lumen package (i.e., an increased energy saving lamp with increased lumens in the same size or preferably in a smaller size).

### SUMMARY OF THE DISCLOSURE

In an exemplary embodiment, a low pressure mercury vapor discharge lamp includes a discharge tube forming a continuous arc path with electrodes disposed at each end of the path. A fill gas is disposed within the discharge tube. The lamp further includes a ballast circuit board operatively connected to the electrodes for controlling current in the discharge tube. The discharge tube is spirally wound around a longitudinal axis of the lamp to form a partially closed cavity wherein a gap between adjacent turns of the spirally wound discharge tube is closely spaced (i.e., less than about 0.5 mm).

In one embodiment of the disclosure, the discharge tube has a substantially helical shape.

In another embodiment, substantially all of the ballast circuit is incorporated in the cavity formed by the discharge tube.

In still another embodiment, the foregoing combinations includes the spirally wound discharge tube having a generally cylindrical outer conformation.

According to an exemplary embodiment of the disclosure, the gap between adjacent turns of the spirally wound discharge tube arrangement is about 0.0009 mm.

In yet another embodiment, a method of forming a compact fluorescent lamp includes providing a discharge tube forming a continuous arc path with electrodes disposed at each end of the path. The method further includes disposing a fill gas within the discharge tube and connecting a ballast circuit board for controlling current to the electrodes. The method further includes spirally winding the discharge tube arrangement around a longitudinal axis of the lamp and forming at least a partially closed cavity. The method further includes providing a gap between adjacent turns of the spirally wound discharge tube that is sufficiently small to prevent an associated elongated object having a transverse cross-sectional dimension larger than 1.0 mm from passing through the gap, and may be preferably less than approximately about 0.5 mm, and more preferably about 0.0009 mm.

A primary benefit is a decreased need for an extra ballast housing to cover the ballast circuit by using a coiled glass discharge tube.

Another primary benefit is a covered ballast circuit which provides increased protection against inadvertent contact with the ballast by using a coiled discharge tube having closely spaced adjacent turns.

Another primary benefit is a higher lumen per wattage due to a combination of a longer discharge arc length, and a lower arc current while using the equivalent power to current lamp technology.

Another benefit is a higher lumen package (greater than about 40% light emitting surface area) due to a combination of a longer discharge arc length (e.g., about twice the length) with a maximum overall length and maximum overall diameter that is equivalent to current lamp technology.

A further benefit is a decrease in lamp maximum overall length (MOL) of about 25% while using an equivalent power to current lamp technology.

A still further benefit is a reduction in cost.

Yet another benefit is a lamp that is environmentally friendly as a result of using less plastic raw material.

Other benefits and advantages of the present disclosure will be realized upon reading and understanding the following detailed description.

### BRIEF DESCRIPTION OF THE DRAWINGS

FIG. 1 is a cross-sectional view of an exemplary embodiment of a compact fluorescent lamp.

FIG. 2 is an elevational view of the compact fluorescent lamp of FIG. 1.

### DETAILED DESCRIPTION OF THE PREFERRED EMBODIMENTS

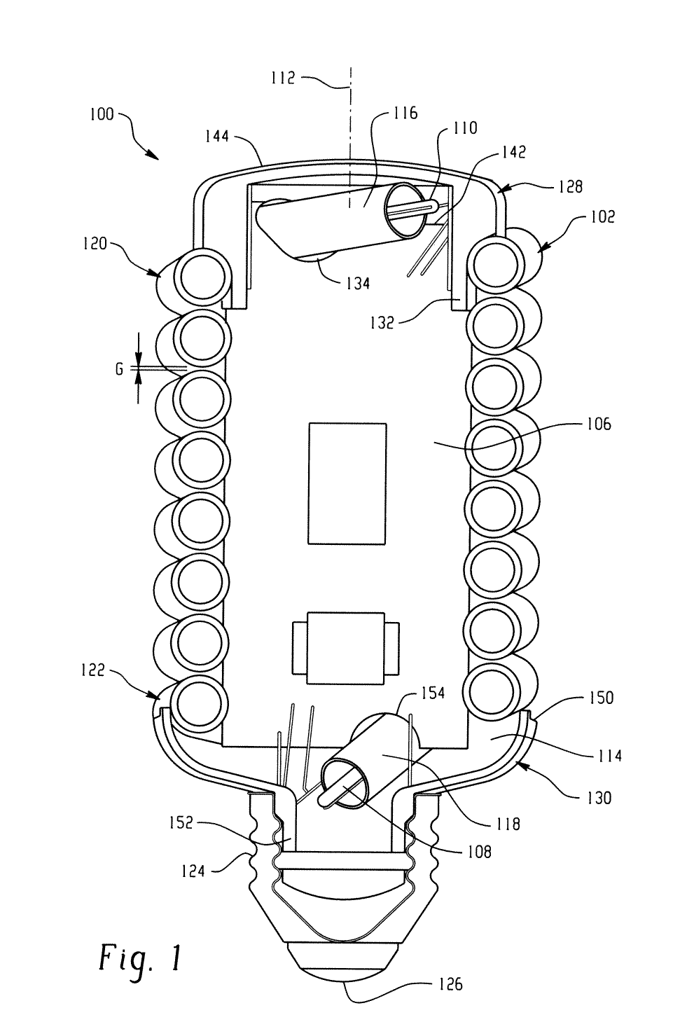

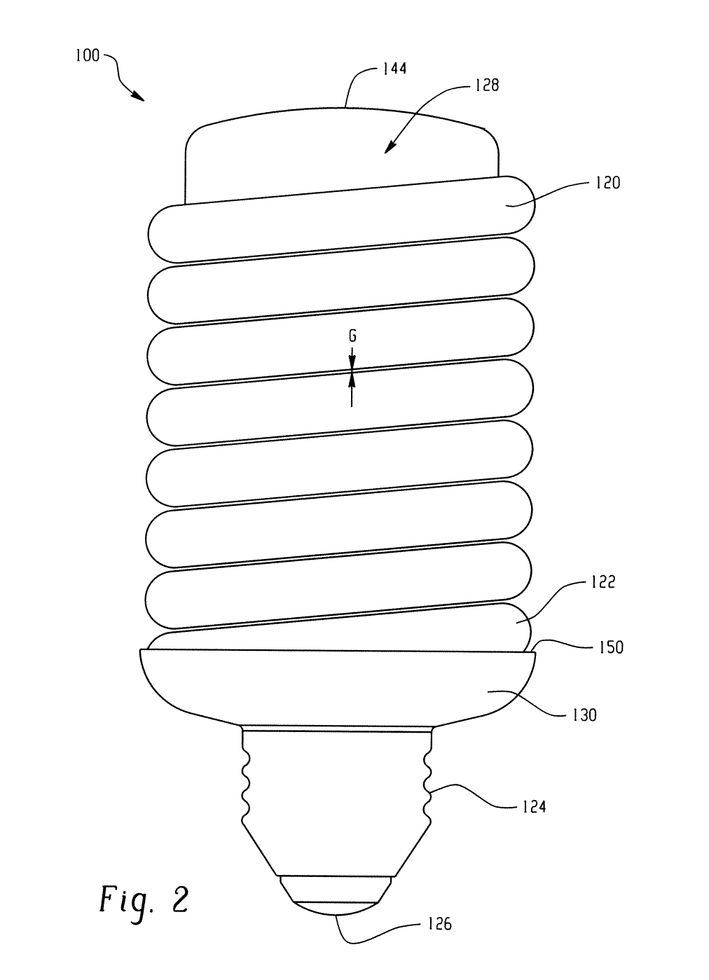

An exemplary compact fluorescent lamp 100 is shown in FIGS. 1 and 2. The compact fluorescent lamp includes a discharge tube 102 and a ballast circuit board 106 for controlling current in the tube. Generally, the structure and operation of the discharge tube 102 is well known to a person skilled in that art. The discharge tube encloses a discharge volume filled with a discharge gas and has a phosphor coating disposed along the inner surface thereof. In the preferred embodiment, a continuous arc path is created between electrodes 108, 110 disposed at each end of the arc path in the elongated tube 102. The discharge tube 102 in this arrangement is spirally or helically wound around a longitudinal axis 112. As evident in FIGS. 1 and 2, each turn of the winding is at a substantially constant diameter relative to each adjacent turn so that the entire tube forms a substantially cylindrical lamp that encloses an inner, at least partially closed cavity 114 (FIG. 1). A close gap G between adjacent turns of the spirally wound discharge tube for an exemplary embodiment, is generally less than about 0.6 mm, e.g. about 0.5 mm, and more preferably is on the order of about 0.0009 mm. A total number of turns of the spirally wound discharge tube can be at least about four, and generally less than about nine, and more preferably eight. First and second terminal ends 116, 118 of the discharge tube are disposed adjacent an upper, first end 120 and a lower, second end 122 of the spiral conformation (FIG. 1).

This arrangement of the discharge tube with the close gap G between adjacent turns advantageously offers enhanced protection against inadvertent or accidental contact with powered components since the probability of inadvertent contact with electrical components located in the cavity is reduced. More particularly, the discharge tube 102 is a substantially coiled or helical shape and the inner cavity 114 is dimensioned to incorporate substantially all of the ballast circuit board 106. In the preferred arrangement, the ballast circuit board 106 is mounted substantially parallel with the axis 112 between first and second ends 116, 118. Respective first and second electrodes 108, 110 are operatively connected to the circuit board which, in turn, is operatively connected with an electrically conductive threaded base or shell 124 and with electrical contact 126 that is spaced from the shell by an electrically insulating material. Of course this is but one embodiment of an electrical type contact that can be used to establish mechanical and electrical connection with an associated lamp fixture (not shown) without departing from the scope and intent of the present disclosure. By incorporating at least a portion of the circuit board with the cavity of the discharge tube, the maximum overall length of the lamp assembly is advantageously reduced when compared to known arrangements.

The coiled discharge tube is supported by first and second end members or support members 128, 130. The upper support member 128 has a groove or recess 132 that at least partially receives a portion of a winding of the discharge tubes and further includes an opening/recess (FIG. 1) dimensioned to receive the end 116 of the discharge tube therethrough. The circuit board may also be dimensioned or recessed as noted by reference numeral 134 to accommodate the discharge tube end 120 if necessary. Still further, the upper support member includes an internal groove or slot that preferably receives a peripheral edge 142 of a first or upper end of the circuit board. Further, an outer surface 144 of the upper support member 128 provides an aesthetically pleasing appearance that merges with the remainder of the lamp assembly.

In a similar fashion, the second or lower support member 130 operatively engages the lower end 118 of the coiled discharge tube and a lower end of the printed circuit board 106. The lower support member 130 also provides a smooth transition between the discharge tube 102 and the lamp base 124. More particularly, the lower support member 130 has a first or upper end 150 that receives at least a portion of a winding of the discharge tube. The lower support member 130 then transitions in dimension toward a second, narrower end 152 that is received in the Edison-type lamp base 124. Further, recess 154 is preferably formed in a lower end of the circuit board to accommodate end 118 of the discharge tube. The lower support member 130 provides an aesthetically pleasing, smooth transition between the outer cylindrical conformation of the discharge tube and the narrower lamp base 124, while providing desired mechanical support for the discharge tube, interconnection with the base 124, and mechanically stabilizing the circuit board 106.

The upper and lower support members 128, 130 can be made of the same material, preferably a plastic.

Without intending to limit the exemplary embodiment, the following Examples demonstrate the ability to obtain a substantially extended arc length without adversely impeding or increasing other dimensions of the lamps.

### Example 1

| | Existing 12 W Lamp | New 12 W Lamp |
|---|---|---|
| Maximum Length | 112 mm | 112 mm |
| Spiral Height (8 turns) | 64 mm | 64 mm |
| Arc Length | 400 mm | 1107 mm |
| Arc Diameter | 45 mm | 50 mm |
| Tube Diameter | 8 mm | 8 mm |

In summary, the present disclosure achieves an increase in lumens per watt or lamp efficacy and lumen package in a same or reduced lamp size. A self-ballasted compact fluorescent lamp (CFL) is provided by the present disclosure that includes a ballast housing to incorporate the lamp control gear and secures the discharge tube and the base. The housing protrudes from the field surrounded by the glass body which together determines the lamp maximum overall length (MOL). In order to achieve these advantageous features, the discharge tube arrangement is spirally wound wherein the gap between the adjacent turns is reduced close to zero while the sealed ends of the discharge tube are preferably disposed at opposite ends. The gap between adjacent turns of the spirally wound discharge tube is sufficiently small to preclude a user's finger from passing through the gap and limiting the potential for contact with the ballast. The spiral glass body of the discharge tube serves as a housing that forms an internal cavity to receive the ballast. The length of the discharge tube advantageously increases without increasing the lamp overall size and may even reduce the size. There is also provided a higher lumen package as the power of the longer discharge tube increases (when operating on the same arc current) resulting in higher lumen output. Furthermore, due to the reduced thermal stress on the ballast components, the system may be more reliable.

The technical advantages of the present disclosure include a longer discharge arc length (more than twice) having an increase in lumens per wattage (Lm/watt) or lamp efficacy. The light source is more efficient operating at a lower arc current and the same power as current light sources. Other advantages include a longer discharge arc length (more than twice), a higher lumen package with a greater light emitting surface with the same maximum overall length (MOL), and an approximate 40% increase in maximum overall diameter. Another further advantage includes an approximate 20 to 35% decrease in maximum overall length (MOL) of the lamp using the same power. Still further, less plastic is required in the lamp assembly, there is reduced thermal stress on ballast components, and the lamp assembly has a reliable, longer life for approximately the same cost for the ballast.

The ballast circuit board is located inside the cavity created by the wound glass discharge tube. A smaller lamp assembly with the same lumen output is achieved, or stated another way, a higher luminous flux package van be attained in the substantially the same size lamp.

The disclosure has been described with reference to the preferred embodiments. Obviously, modifications and alterations will occur to others upon reading and understanding the preceding detailed description. It is intended that the disclosure be construed as including all such modifications and alterations in so far as they fall within the scope of the following claims.

We claim:

1. A compact fluorescent lamp comprising:
a discharge tube forming a continuous arc path with electrodes disposed at each end of the path;
a fill gas disposed within the discharge tube;
a ballast circuit board for controlling current in the discharge tube and operatively connected to the electrodes;
the discharge tube being spirally wound around the longitudinal axis of the lamp to form a partially closed cavity; and
wherein a gap between adjacent turns of the spirally wound discharge tube are closely spaced.

2. The lamp of claim 1, wherein the discharge tube has a substantially helical shape.

3. The lamp of claim 1, wherein substantially all of the ballast circuit board is incorporated in the cavity of the discharge tube.

4. The compact fluorescent lamp of claim 1 wherein the gap between adjacent turns of the spirally wound discharge tube is less than about 0.5 mm.

5. The compact fluorescent lamp of claim 1 wherein the gap between adjacent turns of the spirally wound discharge tube is about 0.0009 mm.

6. The compact fluorescent lamp of claim 1 wherein the spirally wound discharge tube has a generally cylindrical outer configuration.

7. The compact fluorescent lamp of claim 1 wherein the discharge tube is formed of glass.

8. The compact fluorescent lamp of claim 1 wherein first and second ends of the discharge tube are disposed adjacent to first and second ends of the spirally wound conformation.

9. The compact fluorescent lamp of claim 8, wherein the ballast circuit board is elongated between first and second ends thereof which are operatively connected to the respective first and second electrodes.

10. The compact fluorescent lamp of claim 1 further comprising a phosphor coating disposed on an inner surface of the discharge tube.

11. A method of forming a compact fluorescent lamp comprising:
providing a discharge tube forming a continuous arc path with electrodes disposed at each end of the path;
disposing a fill gas within the discharge tube;
connecting a ballast circuit board for controlling current in the discharge tube with the electrodes;
winding spirally the discharge tube around the longitudinal axis of the lamp forming a partially closed cavity; and
providing a gap between adjacent turns of the spirally wound discharge tube to be sufficiently small to prevent an associated elongated object with a transverse cross-sectional dimension larger than 1.0 mm from passing through the gap.

12. The method of forming a compact fluorescent lamp of claim 11, providing the discharge tube having a substantially helical shape.

13. The method of forming a compact fluorescent lamp of claim 11, incorporating a substantial entirety of the ballast circuit board in the at least partially closed cavity of the discharge tube.

14. The method of forming a compact fluorescent lamp of claim 11, providing a minimum gap between adjacent turns of the spirally wound discharge tube less than about 0.5 mm.

15. The compact fluorescent lamp of claim 14, wherein a minimum gap between adjacent turns of the spirally wound discharge tube arrangement is about 0.0009 mm.

16. The method of forming a compact fluorescent lamp of claim 11, forming the discharge tube from glass.

17. The method of forming a compact fluorescent lamp of claim 16 forming the discharge tube into a substantially cylindrical conformation.

18. The method of forming a compact fluorescent lamp of claim 17 enclosing substantially the entirety of the ballast circuit board.

19. The method of forming a compact fluorescent lamp of claim 11 further providing comprising disposing a phosphor coating on an inner surface of the discharge tube.
